(19) United States
(12) Patent Application Publication
(10) Pub. No.: US 2023/0065948 A1
(43) Pub. Date: Mar. 2, 2023

(54) METHODS AND SYSTEMS FOR FACILITATING INCORPORATION OF DATA TYPES WHEN ASSESSING CREDIT

(71) Applicants: Pavlo Martinovych, Kyiv (UA); Dmytro Norenko, Charlotte, NC (US); Vladyslav Hordiychuk, Lviv (UA); Serhii Hladchenko, Kyiv (UA)

(72) Inventors: Pavlo Martinovych, Kyiv (UA); Dmytro Norenko, Charlotte, NC (US); Vladyslav Hordiychuk, Lviv (UA); Serhii Hladchenko, Kyiv (UA)

(21) Appl. No.: 17/897,263

(22) Filed: Aug. 29, 2022

Related U.S. Application Data
(60) Provisional application No. 63/237,752, filed on Aug. 27, 2021.

(51) Int. Cl. G06Q 40/02; G06F 16/25

(52) U.S. Cl. CPC G06Q 40/025; G06F 16/258

(57) ABSTRACT

The disclosed computer-implemented method may include accessing data from multiple different data sources, where each data source in the multiple different data sources is associated with a common objective. The method may include restructuring the accessed data from a plurality of different data sources of the multiple different data sources into a unified format and optionally analyzing the accessed data to determine and calculate key performance indicators (KPIs). Optionally, the method may include providing original format data from the plurality of different data sources. Still further, the method may include generating, transmitting, and implementing at least one operational step that is to be taken to further the common objective into credit score calculation models. Various other methods, systems are also disclosed.

### CROSS-REFERENCE TO RELATED APPLICATIONS

This application claims priority to and the benefit of U.S. Provisional Patent Application No. 63/237,752, filed Aug. 27, 2021, which application is incorporated by reference herein in its entirety.

### FIELD OF THE INVENTION

Generally, the present disclosure relates to the field of data processing. More specifically, the present disclosure relates to methods and systems for facilitating incorporation of data types when assessing credit.

### BACKGROUND OF THE INVENTION

The field of data processing is technologically important to several industries, business organizations, and/or individuals.

It is common knowledge that credit score plays a key role in current life. Practically every major financed purchase in modern society involves the determination of the purchaser's credit score before financing is approved. For example, the difference between a “good” credit score and an “average” credit score can be associated with literally thousands of dollars in excess interest expenses, fees, and even insurance premiums. Lenders mainly decide credit terms based on a credit score, but employers, insurers, and rental property owners are also looking at credit reports. Doing the right things to build a credit profile is one of the most important items that have to be a top priority for modern business owners and individuals.

Commonly, when it comes to dealing with a low credit score, there are quite a few steps that can be taken to improve it, for example: limiting the number of credit applications, paying rent or mortgage on time, paying utility bills on time, paying a credit card on time each month (either paying in full or paying more than the minimum repayment), filing a complaint to dispute or removing incorrectly listed information. The above actions will make credit rating go up in the long run, but in the short term, one on-time payment will not increase the credit score. Usually, it takes some time and a certain number of “right” transactions in credit history for a credit score to go up a few points. In such circumstances, it is hardly realistic to get an urgently needed loan or service, if the credit rating for whatever reason was low. Conventional data sources for credit scoring do not provide such a possibility.

Another way is to start the credit repair process offered by for-profit credit repair companies. Credit repair is a process that claims to “clean up” an entity's credit report by removing any incorrect negative items. Once these negative items are removed, most entities may see their credit score improve. The credit repair company looks for bankruptcies, charge-offs, tax liens, and other derogatory notations on the entity's credit reports. When they identify these items, they will create a plan to dispute errors and negotiate with the credit bureaus to remove the negative entries. Generally, this is a rather long-term and manual process, which, moreover, is quite expensive.

Further, the conventional methods of reconsideration (improving) credit scores do not provide automatic, instant, and fair recalculation of the entity's credit score.

Further, the issue of a credit score calculation is a “thin file” customer's credit history. A “thin file” refers to the credit report of someone with little or no credit history. Entities who are just starting out and may never have taken out a loan or had a credit card have thin files. A thin credit file typically refers to credit history with fewer than five credit accounts on a credit report maintained by credit bureaus. That credit report, which includes information on how much the business or person has borrowed and whether they have paid their bills on time, is used to calculate their credit score and may be reviewed by prospective lenders to determine how creditworthy they are. Having a thin file can make it difficult to obtain credit or be approved for a loan because it gives credit bureaus very little information with which to judge the business or person's creditworthiness. To get around that problem, credit bureaus will have to take into account another source of information, or will lose the “thin file” credit history client market segment, otherwise.

At the same time, every modern business relies on data. It is nearly impossible to make big moves and grow without tracking the various details affecting operations on a daily basis. For example, salespeople no longer store their contacts in a Rolodex. They use a customer relationship management (CRM) software platform. Retail businesses have replaced their traditional cash registers with digital point-of-sale systems (POS systems). Almost any business process can now be managed by desktop and web software, mobile apps, or other technology. That said, every business has valuable business data that can tell much more about the business creditworthiness than the traditional history of credit payments.

Thus, there is a need in the art for systems and methods, primarily used to improve the accuracy and performance of credit score calculation, which are easy to use, efficient, and capable of automatically and without user interaction.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

In some embodiments, a computer-implemented method is provided. The method may include accessing data from external data sources, each data source in the external data sources being associated with a common objective. The method may further include restructuring the accessed data from a plurality of different data sources in the external data sources into a unified format. Optionally, the method may include analyzing the accessed data to determine and calculate key performance indicators (KPIs). Optionally, the method may include providing original format data from the plurality of different data sources. The method may also include generating at least one operational step that is to be taken to further the common objective. The method may further include transmitting at least one operational step that is to be taken to further the common objective and implementing at least one operational step.

In some embodiments, the at least one operational step includes providing the one or more determined and calculated KPIs to the credit bureau.

In some embodiments, the KPIs include a set of parameters consisting at least of KPIs identification information, KPIs values information, KPIs dynamics information, and KPI benchmark information.

In some embodiments, the at least one operational step includes providing one or more credit score advice to the credit bureau.

In some cases, the at least one operational step includes changing at least one operational parameter associated with a credit scoring engine.

In some embodiments, the at least one operational step includes a notification indicating for the entity and/or credit bureau about one or more effects of the at least one operational step.

In some embodiments, at least one operational step includes providing the unified format data to the credit bureau.

In some embodiments, the step of accessing data from the plurality of different data sources is automatically performed on a specified periodic basis.

In some embodiments, the method further comprises predicting, based on one or more factors, at least one outcome of the at least one operational step.

In some embodiments, the method further comprises business valuation determination based on the data dependencies and the determined KPIs.

In some embodiments, the plurality of different data sources includes at least one of: accountancy data, web and/or business analytics data, banks & banking data, customer relationship management (CRM) data, cryptocurrency data, eCommerce data, enterprise resource planning (ERP) data, e-wallets, and payment processing data, logistics/third-party logistics data, marketing data, payroll data, point of sale (POS) terminal data, public registry data, subscription management data, eSignature, and contract management data, non-fungible token assets data, or metaverse property data.

In some embodiments, the restructuring of the accessed data from the plurality of different data sources into the unified format includes standardizing the data according to which category of software application the data was received from.

In some embodiments, the restructuring of the accessed data from the plurality of different data sources into the unified format includes analyzing a class, type, or subtype of each account from a plurality of accounts and recoding the data into universal reference values.

In some embodiments, the restructuring of the accessed data from the plurality of different data sources into the unified format further includes storing the restructured data in a universal and denormalized data structure.

In some embodiments, the stored restructured data is categorized by application category in a columnar database.

Further, in some embodiments, a system is provided. The system may include at least one physical processor and physical memory comprising computer-executable instructions that, when executed by the physical processor, cause the physical processor to: access data from external data sources, each data source in the external data sources being associated with a common objective and restructure the accessed data from a plurality of different data sources in the external data sources into a unified format; optionally analyze the accessed data to determine and calculate key performance indicators (KPIs) values; optionally provide original format data from the plurality of different data sources; generate at least one operational step that is to be taken to further the common objective, transmit at least one operational step that is to be taken to further the common objective, and implement at least one operational step.

In some embodiments, the system further comprises a data accessing module, a data restructuring module, a data storage module, a post-processing service module, an administrative service module, and an entity's interface module.

In some embodiments, the machine learning module of the system may be operated as a part of a calculation engine of the post-processing service module.

In some cases, the stage of determining and calculating KPIs and/or stage of the one or more operational steps generating that is to be taken is performed using machine learning.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flow diagram of an exemplary computer implemented method of usage of alternative data sources for credit score reconsideration.

FIG. 2 illustrates a computing environment in which the embodiments described herein may operate.

FIG. 3 illustrates different types of third-party client data sources in the at least one data source, in accordance with some embodiments.

FIG. 4 illustrates an embodiment in which an identified operational step may be carried out in multiple ways.

FIG. 5 illustrates a workflow of a data updating process as used to provide actionable operational steps.

FIG. 6 illustrates a workflow of a token-based authorization method for secure data transfer, in accordance with some embodiments.

FIG. 7 illustrates an embodiment of a machine learning (ML) module that includes a plurality of different ML components.

FIG. 8 is an illustration of an online platform consistent with various embodiments of the present disclosure.

FIG. 9 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating incorporation of data types when assessing credit, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more input data, output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating incorporation of data types when assessing credit. Further, the present disclosure describes methods and systems that are designed to improve the accuracy and performance of credit score calculation of entities, including businesses and individuals, and facilitate the construction of trusting relationships between entities and credit bureaus and/or lending institutions, particularly subsequent usage of alternative or additional data sources in the credit score calculation and/or reconsideration process.

Prior/conventional credit score calculation methods, on the other hand, were very limited in the number of data sources implemented. Basically, credit bureaus collect and maintain relatively the same information for credit reports. At the same time, each bureau builds its own scoring models on its own records and might not have all available information. Generally speaking, each credit score is based on credit history, which includes an exhaustive list of information: number of open accounts, total levels of debt, repayment history, demographic indicators, etc. Business credit scores are calculated based on a company's credit obligations and repayment histories with lenders and suppliers, legal filings such as tax liens, pending lawsuits, judgments, or bankruptcies. Legal entity's type and corporate structure, how long it has been operating, and repayment performance relative to that of similar businesses are also taken into account.

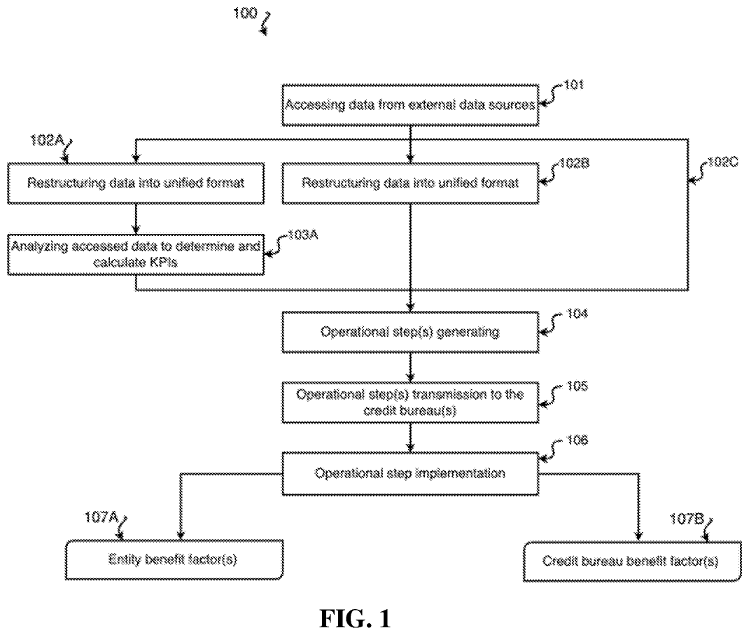

The embodiments described herein, in contrast, may take into account multiple different external data sources from multiple areas of an entity's operations. These embodiments may initiate or be involved in the entity's credit score calculation process, through preparing and implementing actionable and relevant computer system action(s) that are also referred to as operational step(s) herein. These operational step(s) may include physical actions performed on physical processes, some of which may be automatically carried out by computer systems or other machines. Other operational steps may include software-based processes that may be carried out through software applications. In some cases, machine learning models may be trained to identify and prepare these operational step(s). Still further, in at least some embodiments, machine learning models may be trained to determine which operational step(s) to carry out and then initiate those steps. Moreover, at least in some cases, machine learning models may be trained to predict potential outcomes related to the implementation of different operational steps, and provide those predictions to decision-making entities (e.g., credit bureaus). Each of these embodiments will be described in greater detail below with regard to FIGS. 1-7.

Features from any of the embodiments described herein may be used in combination with one another under the general principles described herein. These and other embodiments, features, and advantages will be more fully understood upon reading the following detailed description in conjunction with the accompanying drawings and claims.

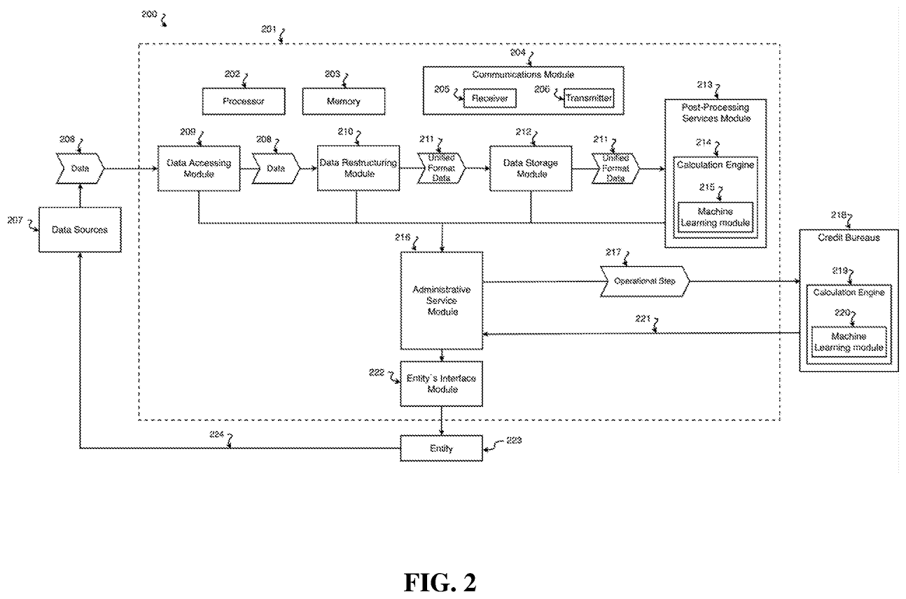

FIG. 1 is a flow diagram of an exemplary computer-implemented method 100 for providing actionable, operational step(s) to a credit bureau 218 (as shown in FIG. 2) for improving the accuracy and performance of an entity's credit score calculation. Further, the exemplary computer-implemented method (or method) 100 may describe usage of alternative data sources for credit score reconsideration. The steps shown in FIG. 1 may be performed by any suitable computer-executable code and/or computing system, including a system as illustrated in FIG. 2. In one example, each of the steps shown in FIG. 1 may represent an algorithm whose structure includes and/or is represented by multiple sub-steps, examples of which will be provided in greater detail below.

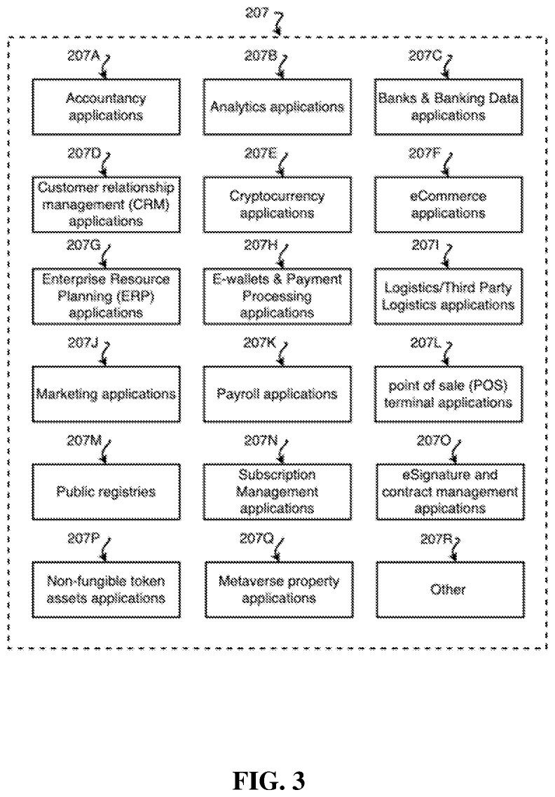

As illustrated in FIG. 1, at step 101, one or more of the systems described herein may access data 208 (as shown in FIG. 2) from a plurality of different external data sources 207 (as shown in FIG. 2). In the preferred embodiment, an entity 223 (as shown in FIG. 2) at its own discretion grants access to related data sources (at 224). Each of the data sources in the plurality of different external data sources 207 may be associated with a common objective. Thus, for example, a data accessing module 209 (as shown in FIG. 2) may access the data 208 from one or more different external data sources 207A-207R (as shown in FIG. 3). Further, the one or more different external data sources 207A-207B may include web analytics data, payroll data, and other types of data. Each of these types of data may represent different aspects of operations that are performed by an entity (such as the entity 223). Each of these types of data may also include indications of areas where improvements may be made to certain operational step(s).

Further, the method 100 of FIG. 1 next includes at least 3 embodiments of actions sequence with the accessed data 208. Further, a first embodiment of the third embodiment lies in restructuring the accessed data from the plurality of different data sources into a unified format data 211 as shown in FIG. 2 (at 102A) and (at 103A), subsequently analyzing accessed data to determine and calculate various business metrics, which may be taken into account in the credit score calculation process. These business metrics are also referred to as “key performance indicators” or “KPIs” herein. For implementation step 102A, a data restructuring module 210 of FIG. 2 may restructure the accessed data 208 into a unified format data 211. Each of the various data types accessed from the different data sources 207A-207R may be structured or formatted differently. Some data may include amounts of currency, some data may include warehouse information, some data may include a number of customers or sales, and some data may include web analytics, customer acquisition channels, or other data. Each of these different types of data may represent different operational aspects of the entity 223. The data restructuring module 209 may access each of the various types of data and restructure that data into the unified format data 211 that allowing the different types of data to be analyzed side-by-side in a coherent and functional manner. Achieving the unified format may include removing data, adding data, recategorizing data, moving data to different locations, or performing other operations on the data. This restructuring may preserve the underlying dependencies between the data types so that they are later discoverable while transforming the data from a conglomeration of different data formats to a single, unified data format. The process of determining and calculating KPIs is described in more detail below. The result of the implementation of such embodiment may be used at the operational step(s) generating stage at 104. At stage 104, a post-processing module 213 (as shown in FIG. 2) generates at least one operational step 217 using the KPI values that were obtained in the previous stage 103A.

After the operational step(s) generating (at 104) is done, the claimed method 100 suggests the transmission of the operational step(s) to the credit bureau(s) 218 at (105). The generated one or more operational step(s) 217 in the form of generated KPI values in any machine-readable and/or human-readable instructions is transmitted to the credit bureau 218 (at stage 105) by an administrative service module 216 (as shown in FIG. 2) of the system 201 and also by using at least one data transfer unit (e.g., API). The credit bureau 218, at its discretion, may implement the received KPIs into credit score calculation models and realize the operational step implementation stage (credit score reconsideration) at 106. The credit bureau 218 may independently determine which KPIs should or should not be taken into account in each case, a priority of various KPIs, conditions for their implementation, etc.

The implementation of the claimed method 100 is mutually beneficial for both parties. Thus, a credit bureau benefit factor(s) 107B may consist in a greater number of different external data sources that allow the credit bureau 218 more accurate and deeper credit score calculating, and therefore, help to increase credit bureau services sales, etc.

On the other hand, the entity's beneficial factor 107A lies in sharing a wide range of additional data sources and being able to improve their credit score. For example, an individual may prefer to keep a significant part of their savings and conduct settlement transactions by using various crypto assets. Traditional/conventional methods of credit score calculating mainly include the analysis of an entity's bank balance sheet, transactions and bankruptcy reports, which would not allow valuation of crypto assets, and, accordingly, would not allow for a correct assessment of the client's solvency.

In the preferred embodiment, the credit bureau 218 can inform the entity 223 through an interface module 222 (as shown in FIG. 2) that the one or more external data sources 207 the entity 223 connect to a system 201 (as shown in FIG. 2), the more likely reconsideration of the credit score.

The alternative embodiment lies in generating the operational step(s), at 104, by using the unified format data 211 directly (at 102B). For executing stages 105 and 106 of the method 100, the administrative service module 216 of the system 201 may transmit the unified format data 211 to the credit bureau 218 and/or to a credit score calculation engine 219 (as shown in FIG. 2) for their subsequent implementation in credit score calculation models. The credit bureau 218 similarly to the first embodiment may independently determine which unified format data should or should not be taken into account in each case.

Another alternative embodiment lies in generating the operational step(s) 104 by providing original format data from the one or more different external data sources 207 to the credit bureaus 218 (102C stage) as an operational step generating stage 104. For executing the stage 105 and 106 of the method 100, the administrative service module 216 of the system 201 transmits original format data to the credit bureau 218 and/or to the credit score calculation engine 219 for their subsequent processing and implementation in credit score calculation models. Such original data may also be unified by the credit bureau 218 or third-party systems.

Generally, various embodiments (102A, 103A), (102B), and (102C) explain technically different options for achieving the common objectives.

FIG. 2 illustrates a computing environment 200 that includes the computer system 201, in accordance with some embodiments. Accordingly, the computer system 201 may include at least one physical processor (or processor) 202 and a physical memory (or at least some system memory) 203 comprising computer-executable instructions that, when executed by the physical processor 202, cause the physical processor 202 to access data from external data sources, each data source in the external data sources being associated with a common objective, restructure the data from the plurality of different data sources into a unified format, optionally analyze the data to determine and calculate key performance indicators (KPIs) values, optionally provide original format data from the plurality of different data sources, generate at least one operational step that is to be taken to further the common objective; transmit the at least one operational step that is to be taken to further the common objective, and implement at least one operational step.

Further, in some embodiments, the system 201 comprises the data accessing module 209, the data restructuring module 210, a data storage module 212, the post-processing service module 213, the administrative service module 216, and the interface module (or entity's interface module) 222.

Further, in some embodiments, the machine learning module may be operated as a part of a calculation engine 214 (as shown in FIG. 2) of the post-processing service module 213.

Further, in some embodiments, the stage of determining and calculating the KPIs and/or stage of the at least one operational step generating that is to be taken is performed using machine learning.

Further, the computer system or system 201 may include software modules, embedded hardware components such as processors, or includes a combination of hardware and software. Further, the computer system 201 may include substantially any type of computing system including a local computing system or a distributed (e.g., cloud) computing system. In some cases, the computer system 201 may include the at least one processor 202 and the at least some system memory 203. Further, the computer system 201 may include program modules for performing a variety of different functions. The program modules may be hardware-based, software-based, or may include a combination of hardware and software. Each program module may use computing hardware and/or software to perform specified functions, including those described herein below.

The computer system 201 may include a communications module 204 that is configured to communicate with other computer systems. The communications module 204 may include any wired or wireless communication means that can receive and/or transmit data to or from other computer systems. These communication means may include hardware interfaces including Ethernet adapters, WIFI adapters, hardware radios including, for example, a hardware-based receiver 205, a hardware-based transmitter 206, or a combined hardware-based transceiver capable of both receiving and transmitting data. The radios may be cellular radios, Bluetooth radios, global positioning system (GPS) radios, or other types of radios. The communications module 204 may be configured to interact with databases, mobile computing devices (such as mobile phones or tablets), embedded, or other types of computing systems.

The computer system 201 may also include the data accessing module 209. The data accessing module 209 may access various types of data from the one or more different external data sources 207. In the preferred embodiments, each data source in the one or more different external data sources 207 is a software application (including but not limited to web, mobile, desktop applications, etc.). For instance, in some cases, the data accessing module 209 may access the data 208 from the at least one data source 207A-207R.

Further, a data source 207A (as shown in FIG. 3) of the at least one data source 207A-207R may include data related to accounting (e.g., but not limited to Bexio, Expensify, FreeAgent, FreshBooks, Invoiced, Kashoo, Practice Panther, QuickBooks, QuickBooks Desktop, Sage Business Accountancy, Wave, Xero applications, etc.).

Additionally or alternatively, the data accessing module 209 may access the data 208 from a data source 207B (as shown in FIG. 3) of the at least one data source 207A-207R, which may include web and/or business analytics data that may be used for the measurement, collection, analysis, and reporting of web data to understand and optimize web usage (e.g. but not limited to Google Analytics, Matomo (Piwik) Analytics, Mixpanel, etc.).

Further, a data source 207C (as shown in FIG. 3) of the at least one data source 207A-207R may include banks & banking data (e.g., but not limited to Banking Data Aggregator, Plaid, Yodlee, etc.).

Further, a data source 207D (as shown in FIG. 3) of the at least one data source 207A-207R may include customer relationship management (CRM) data (e.g., but not limited to Agile CRM, Bill4Time, Bitrix24, Clio, Copper, Docketwise, Follow Up Boss, HubSpot CRM, Infusionsoft, Insightly, Pipedrive, Salesforce, Streak, vCita CRM, Zoho CRM, etc.).

Further, a data source 207E (as shown in FIG. 3) of the at least one data source 207A-207R may include cryptocurrency data (e.g., but not limited to CoinMarketCap, Zabo, Binance, Kraken, Trust Wallet, etc.).

Further, a data source 207F (as shown in FIG. 3) of the at least one data source 207A-207R may include eCommerce data (e.g., but not limited to Big Cartel, 3dcart, Amazon, BigCommerce, eBay, Ecwid, Mercadolibre, Shopify, Squarespace, WooCommerce, etc.).

Further, a data source 207G (as shown in FIG. 3) of the at least one data source 207A-207R may include Enterprise Resource Planning (ERP) data (e.g., but not limited to MYOB (Essential), Odoo ERP, Oracle ERP, Skubana, Microsoft ERP, etc.).

Further, a data source 207H (as shown in FIG. 3) of the at least one data source 207A-207R may include e-wallets and payment processing data (e.g., but not limited to PayPal, Square, Stripe, Payoneer, etc.).

Further, a data source 207I (as shown in FIG. 3) of the at least one data source 207A-207R may include logistics/third-party logistics data (e.g., but not limited to ShipBob, ShipStation, DHL, UPS, etc.).

Further, a data source 207J (as shown in FIG. 3) of the at least one data source 207A-207R may include marketing data (e.g., but not limited to Active Campaign, AWeber, Customer.io, Facebook Ads Manager, Facebook Business, Infusionsoft, Instagram For Business, Klaviyo, Mail Chimp, Maileon, Omnisend, Perfect Audience, Send Pulse, Sharp Spring, etc.).

Further, a data source 207K (as shown in FIG. 3) of the at least one data source 207A-207R may include payroll data (e.g., but not limited to ADP, GUSTO, Paychex, Square Payroll, Zenefits, etc.).

Further, a data source 207L (as shown in FIG. 3) of the at least one data source 207A-207R may include point of sale (POS) terminal data (e.g., but not limited to Clover POS, Epos Now, Erply POS, Lightspeed POS, Shopify POS, Square POS for Retail, Vend, etc.).

Further, a data source 207M (as shown in FIG. 3) of the at least one data source 207A-207R may include public registry data (e.g., but not limited to DnB Direct+, Financial Data Exchange, etc.).

Further, a data source 207N (as shown in FIG. 3) of the at least one data source 207A-207R may include subscription management data (e.g., but not limited to Braintree, Chargebee, Chargify, Paddle, etc.).

Further, a data source 207O (as shown in FIG. 3) of the at least one data source 207A-207R may include eSignature and contract management data (e.g., but not limited to DocuSign, Legito, etc.).

Further, a data source 207P (as shown in FIG. 3) of the at least one data source 207A-207R may include non-fungible token assets data (e.g., but not limited to Binance NFT, Metamask, Math Wallet, Alpha Wallet, etc.).

Further, a data source 207Q (as shown in FIG. 3) of the at least one data source 207A-207R may include metaverse property application data (e.g., but not limited to MyLand Metaverse, SuperWorld, etc.).

Further, a data source 207R (as shown in FIG. 3) of the at least one data source 207A-207R may include all other possible data sources, which may provide useful data for credit score reconsideration.

Still further, the data accessing module 209 may access the data 208 from some other type of data associated with the entity 223. Each of the one or more different external data sources 207 may gather information from various ongoing operations. As such, the data 208 may be live, up-to-the-second data. In other cases, the data 208 may be stored as historical data related to any of the above data categories.

FIG. 3 illustrates different types of third-party client data sources in the at least one data source 207A-207R, in accordance with some embodiments.

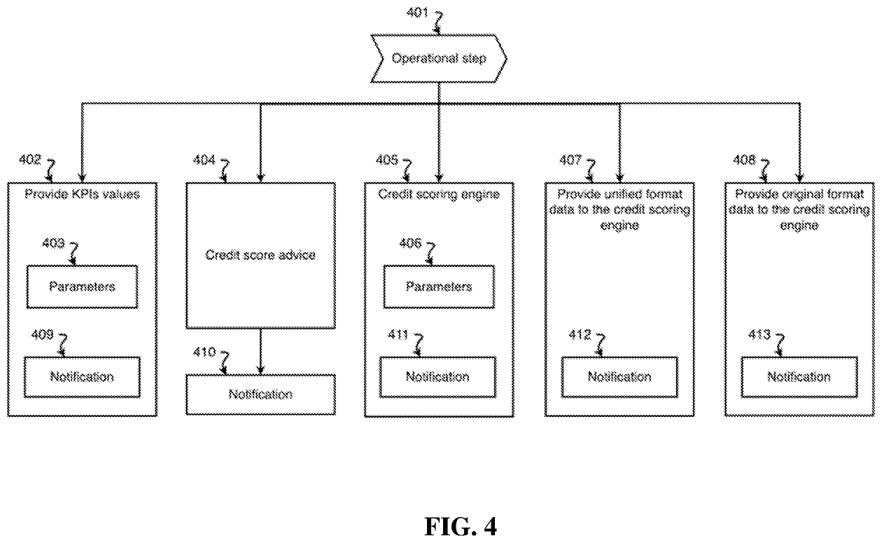

FIG. 4 illustrates an embodiment in which an identified operational step 401 may be carried out in multiple ways, in accordance with some embodiments.

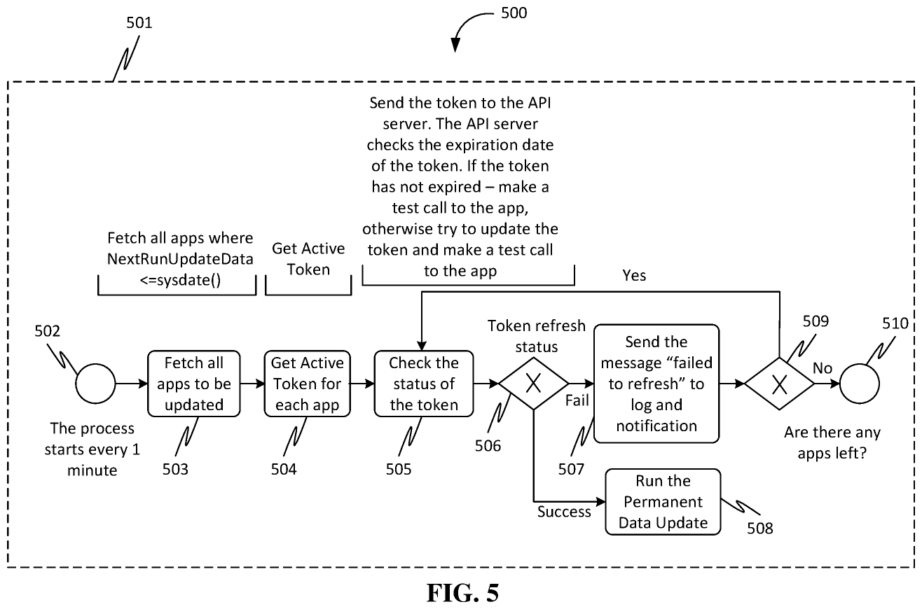

FIG. 5 illustrates a workflow of a method 500 for providing live and up-to-the-second data 208, in accordance with some embodiments. Further, the method 500 may include data updating to provide actionable operational steps. In method 500 of FIG. 5, a periodic data update 501 may start at a point 502. The starting point 502 may recur on a periodic basis (e.g., every one minute). The underlying system may fetch data from each of the applications or other data sources that are to be updated at 503. Further, all apps where NextRunUpdateData<=sysdate( ) may be fetched. At step 504, the underlying system may access an active token for the one or more different external data sources (application) 207 (e.g., accountancy, analytics applications, etc.). At step 505, the underlying system may check the status of the token. Further, the token may be sent to an API server. The API server checks the expiration date of the token. If the token has not expired, a test call may be made to the application, otherwise a try to update the token may be made. Then, a test call may be made to the application. Further, at 506, the token refresh status may be checked. Further, if the status checks failed, at step 507, the system may send a “failed to refresh” message notification and log the failure. If the status checks result in success, the system may run the periodic data update at step 508 and continue performing the updating process (at 509) until each of the one or more different external data sources 207 (e.g., each of the applications) has been updated (at 510). Further, if there are any apps left, after 509, the method 500 may proceed to 505. Within this rubric, the underlying system may issue various API calls to receive data from the one or more different external data sources 207.

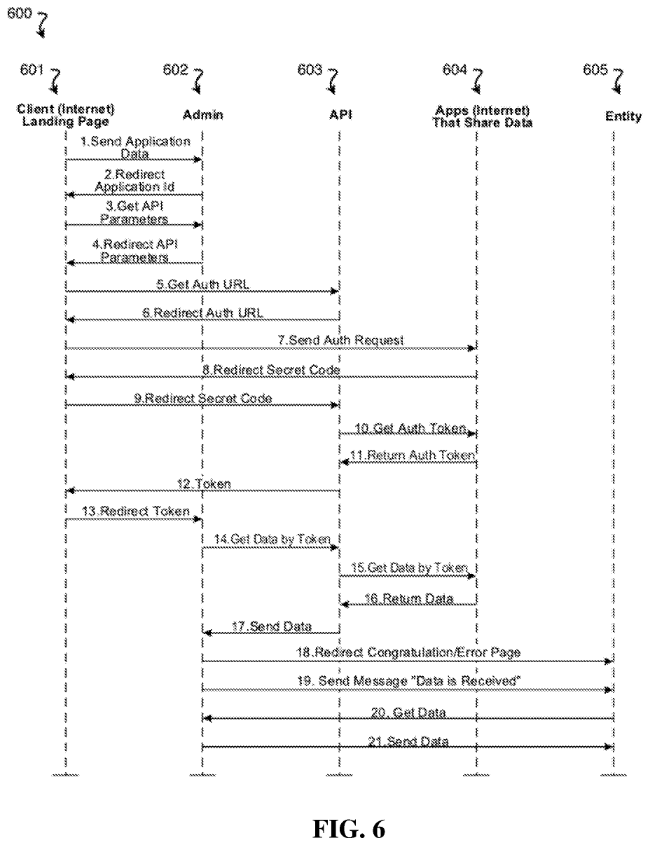

FIG. 6 illustrates a workflow of a token-based authorization method 600 for secure data transfer, in accordance with some embodiments. FIG. 6 provides a preferred realization of step 505 of the periodic data updating process. In the preferred embodiment, the token-based authorization method (or method) 600 of FIG. 6 is the token-based authorization (e.g., OAuth 2.0 protocol) that enables an entity-related information from the one or more different external data sources 207 to be used by the computer system (or the system) 201 without exposing the entity's data sources (application accounts) credentials to the computer system 201. Further, a client 601 may send application data to an administrative computer system 602 (step 1). The administrative computer system 602 may redirect the application identifier to the client 601 (step 2). Further, the client 601 may then request API parameters (step 3), and the administrative computer system 602 may redirect the requested API parameters to client 601 (step 4). Further, the client 601 may then send a request for an authentication uniform resource locator (URL) to a backend API 603 (step 5). The backend API may then redirect the authentication URL to the client 601 (step 6). The client 601 may then send an authentication request to one or more applications 604 that share data (step 7). Further, the one or more applications 604 may then provide a secret code to the client 601 (step 8).

Further, the client 601 may then redirect the secret code to the backend API 603 (step 9). The backend API 603 may then send a request for an authentication token to the one or more applications 604 (step 10). The one or more applications 604 may then return the requested authentication token to the backend API 603 (step 11). The backend API 603 may then send the authentication token to the client 601 (step 12). Upon receiving the authentication token, the client 601 may redirect the token to the administrative computer system 602 (step 13). The administrative computer system 602 may access data using the token through the API (step 14) and from the one or more applications 604 (step 15). Further, the one or more applications 604 may return the requested data through the backend API 603 (step 16) to the administrative computer system 602 (step 17). The administrative computer system 602 may then redirect a congratulation or error page to entity 605 (step 18) or send a “Data is received” message to the entity 605 (step 19). Further, the entity 605 may then request data from the administrative computer system 602 (step 20), and the administrative computer system 602 may respond with the requested data (step 21). In this manner, the underlying system may use tokens (e.g., at 505) to safely and securely access information.

Upon accessing the data 208 through the data accessing module 209, the data restructuring module 210 may restructure the different types of data into a common, unified data format. As will be understood, the one or more different external data sources 207 may collect, organize, and store data differently. In some cases, the computer system 201 may mix data from the one or more different external data sources 207, prior to restructuring the data sources. The mixing may include accessing data from different categories of software applications and combining that data for determining the operational step(s) 217. Some types of data may not mesh with other data types. Moreover, some of the data 208 may be stored in different formats that lack common accessibility. Accordingly, the data restructuring module 209 may restructure some or all of the data 208 into the unified format data 211. In this data cleaning and restructuring process, the data may be standardized according to the data source (application) category. This categorization may save large amounts of computing resources including CPU cycles, memory, and data storage space during subsequent processing. The data from the one or more different external data sources 207 may be standardized according to data source (application) category (e.g., accounting, analytics, CRM, cryptocurrency, marketing, banks, and banking data, e-commerce, public registries, e-wallets, point of sale (POS), logistics, analytics, enterprise resource planning (ERP), payroll, tax information, or the one or more different external data sources 207). The unified format data 211 includes data such as statuses and entity type, entity names (e.g., documents, counterparties, payments, transactions, etc.), financial reports (e.g., balance sheet, profit, and loss), management reports, dates, currencies, and much more. The unified format data 211 includes also the business financial statements (e.g., balance sheet, profit, and loss) from different systems and different countries in one single format is done by analyzing the class, type, and subtype of each account from the chart of accounts and recoded into universal reference values. In at least some cases, the data 208 may be restructured into the unified format data 211 that is understandable to a machine learning model and that is usable to train the machine learning model.

At 212, the unified format data 211 stored in a universal denormalized structure for storing standardized data, is categorized by the data source category (e.g., in a columnar database management system (DBMS)).

The post-processing services module 213 is the main analytical core where the unified format data 211 is processed. The post-processing services module 213 may perform a variety of functions including calculating key business indicators, comparing the dynamics of KPIs, KPIs benchmarking, KPIs forecasting, business valuation determining, operational step(s) generating, etc. In some embodiments, the post-processing services module 213 may be performed in a specified sequence: after receiving a signal from the administrative service module 216 that new data has been uploaded through the data accessing module 209 (e.g., API), has been restructured and unified through the data restructuring module 210 and has been saved in a data storage module at 212, the calculation engine 214 of the post-processing service module 213 may calculate different determined KPIs (e.g., business metrics) based on the accessed data. In some cases, the post-processing service module 213 may determine various KPIs automatically, including using a machine learning module 215 (as shown in FIG. 2). For KPIs forecasting, each KPI, having its associated business logic calculated by the calculation engine 214, may be compared with previous results, and subsequently sent back to the administrative service module 216 to be saved in a database (e.g., ClickHouse, MySQL). In some cases, calculated KPIs values may be retrieved along with additional data from various tables (e.g., universal tables), analyzed, and contextualized in further post-processing.

The KPIs calculated by the calculation engine 214 depends on and determine the type of data sources (such as the one or more different external data sources 207). For example, sales, inventory demand, and average check KPIs are mostly related to the eCommerce data source 207F. At the same time, operating cash flow, working capital, direct cost, operating margin, net profit, cash burn rate, and return on equity KPIs are related to accountancy data source 207A. Further, the analytics data source 207B KPIs are numbers of visitors, page views, session duration, bounce rate, a ratio of new vs returning visitors, average time on page, average page speed, conversion rate, cost per acquisition, average order value, cart abandonment rate, revenue on advertising spend, etc. Employee retention rate and payroll amount (daily, weekly, monthly) are mostly related to the payroll data source 207K. Subscriptions KPIs (new, total, lost) related to the subscription management data source 207N, etc.

In some embodiments, the ability to gather data from other entities may open the possibility of collectively studying, analyzing, and predicting various key performance indicators (KPIs) of different entities. Having data from many different sources and different entities may allow the embodiments herein to capture different aspects of similar businesses or entities and identify the reasons for such differences. Moreover, information, surveys, studies from social media, and other data sources, in combination with the above-mentioned comparisons, may provide a thorough picture of the borrower's trustworthiness and possible improvements in a credit score.

In some cases, KPIs may be defined by business logic. At least one advantage of such an approach is the ability to access data from different sources for distinct but similar entities. For example, if the systems herein observe the growth of company A while similar companies in the same industrial sector, with the same opportunities do not have the same level of growth, the analytical systems described herein may detect the difference and implement the one or more operational steps 217—provide KPIs values at 402 and/or credit score advice at 404 and/or initiate credit score upgrade at 405 and/or provide unified format data to the credit bureau 218 at 407, and/or provide original format data to the credit bureau at 408. Those actions may be based on the comparison of metrics between the two or more businesses, as well as comparisons to established success metrics taken from social media, surveys, or other sources for the same time period and for the same type of company from the same geographic region. In some cases, the embodiments herein may implement a schema to define this process.

Based on the data dependencies and determined KPIs, the post-processing services module 213 may also provide business valuation determinations. The business valuation process tells the owner and credit bureau what the current worth of their business is by analyzing all aspects of the business, including the business management, capital structure, future earnings, and the market value of its assets. Determining the value of a business is useful in the determination of the entity's solvency and for the entity's credit score calculation. Data from the one or more different external data sources 207 may be used to determine the value of the business. Such sources can be accounting (207A), analytics (207B), customer relationship matters (CRM) (207D), enterprise resource planning (ERP) (207G), payroll (207K), e-commerce (207F), cryptocurrency (207E), marketing (207J), and many other data sources.

The schema may include elements or components such as supervised regression models. Although, in some embodiments, for the establishment of similarities between entities, the systems herein may use unsupervised classification models as well. In some embodiments, predictions from different ML models may be combined by applying specific weights. Applying specific weights to different ML models may provide higher precision than just applying a single algorithm. As such, for the KPI predictions described above, the systems herein may generate ML algorithms in a variety of different manners according to the needs and specific characteristics of a given KPI (i.e., different ML algorithms and different weights may be implemented for each KPI prediction). For instance, the systems herein may implement support vector machines, seasonal and trend (STL) decomposition (e.g., using locally estimated scatterplot smoothing (LEOSS), which implements a statistical method of decomposing time series data into three components containing seasonality, trend, and residual data), vector autoregressions, which provides a univariate autoregressive model for forecasting a vector of time series data, and boosting algorithms including XGBOOST and CATBOOST.

The embodiments herein may include a single ensembled model for each KPI. The schema or flow may include various steps including data collection, data preparation, feature generation, and model training and prediction. Separately, the embodiments herein may aim to observe and study anomaly detection on input time series training data. This, on one hand, may serve as part of the normalization process and, on the other hand, may be a good source for the study of new logically unexpected changes. The study of such changes and the processes which stimulate such unexpected changes are of high importance for generating the one or more operational steps 217.

Sector and sub-sector analyses may be implemented as a tool for understanding the various aspects and conditions under which the entity operates. Each industrial sector and the one or more different external data sources 207 respectively may be characterized by a certain set of metrics that are the best fit for a given industry. As such, estimating the right set of KPIs may make it possible for the entity to see the big picture, assess operational activities and overall performance, make operational steps, and realistic forecasts for future periods.

In some cases, in order to create the one or more operational steps 217, two or more KPIs may be combined. These combinations may be based on: 1) mathematical formulas used for KPI calculation where, in these formulas, if either the counter or the denominator overlap, the underlying system may consider that the selected set of KPIs is dependent and correlated to each other, 2) ML models where, while there may be no obvious relevance between the selected set of KPIs, the ML models may analyze the data to make the best estimations what kind of influence may occur if one of the KPI from the selected combination changes or 3) a combination of 1 and 2.

For example, a KPI pair with two different KPIs may include a working capital ratio and an inventory turnover ratio. In one example, the working capital ratio may have a historical value of 1.5 over six months and a forecasted KPI value of 1.3 for the next six months. The inventory turnover ratio may have a historical value of 10% and a forecasted KPI value of 18%. One potential operational step may indicate that the working capital ratio is, in this case, insignificant, but that the inventory turnover increase is a sign of having sufficient demand for the entity's goods or services, and that production of such should be increased.

At least in some cases, the machine learning module 215 may be operated as a part of the calculation engine 214 of the post-processing service module 213. The embodiments described herein may generate and/or train separate ensembled supervised regression models (e.g., using ensemble learning) for each KPI. The trained ML models may be used for generating business metrics forecasts for better credit score reconsideration for future periods. For instance, cash flow forecast as one of the general for business is mainly based on the entity data from the accountancy application 207A or banks & the banking data applications 207C using a combination of machine learning models and classical financial analysis of an enterprise, enhanced by additional data types from a variety of business apps from other categories. The core of the calculation algorithm is the forecast, which combines the method of predicting future bank payments, using the decision tree model based on historical data, projection of payments on invoices or bills for future dates and forecast payments on missed invoices and bills, using the method of evaluation of historical payments for each counterparty.

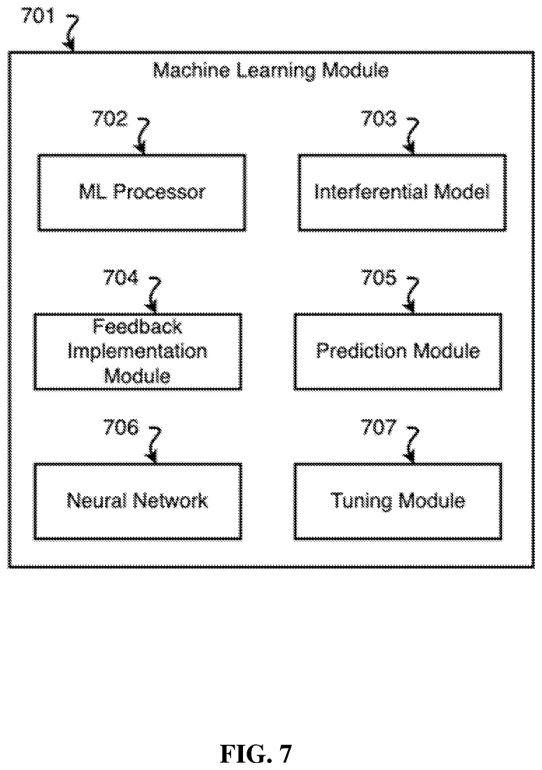

FIG. 7 illustrates an embodiment of a machine learning (ML) module 701 that includes a plurality of different ML components. At least some of the embodiments described herein may train and/or implement a machine learning model. For example, FIG. 7 illustrates the machine learning module 701 that includes various ML-related components. These components may include a machine learning (ML) processor 702, an inferential model 703, a feedback implementation module 704, a prediction module 705, and/or a neural network 706. Each of these components may be configured to perform different functions with respect to training and/or implementing a machine learning model. The ML processor 702, for example, may be a dedicated, special-purpose processor with logic and circuitry designed to perform machine learning. The ML processor 702 may work in tandem with the feedback implementation module 704 to access data and use feedback to train an ML model. For instance, the ML processor 702 may access one or more different training data sets. The ML processor 702 and/or the feedback implementation module 704 may use these training data sets to iterate through positive and negative samples and improve the ML model over time.

In some cases, the machine learning module 701 may include the inferential model 703. As used herein, the term “inferential model” 703 may refer to purely statistical models, purely machine learning models, or any combination of statistical and machine learning models. Such inferential models may include neural networks 706 such as recurrent neural networks. In some embodiments, the recurrent neural network may be a long short-term memory (LSTM) neural network. Such recurrent neural networks are not limited to LSTM neural networks and may have any other suitable architecture. For example, in some embodiments, the neural network 706 may be a fully recurrent neural network, a gated recurrent neural network, a recursive neural network, a Hopfield neural network, an associative memory neural network, an Elman neural network, a Jordan neural network, an echo state neural network, a second order recurrent neural network, and/or any other suitable type of recurrent neural network. In other embodiments, the neural networks 706 that are not recurrent neural networks may be used. For example, deep neural networks, convolutional neural networks, and/or feedforward neural networks, may be used. In some implementations, the inferential model 703 may be an unsupervised machine learning model, e.g., where previous data (on which the inferential model 703 was previously trained) is not required.

At least some of the embodiments described herein may include training a neural network to identify data dependencies, identifying the one or more operational step(s) 217, predicting potential outcomes of the one or more operational step(s) 217, or performing other functions. In some embodiments, the systems described herein may include a neural network that is trained to identify one or more operational step(s) 217 using different types of the data 208 and/or the unified format data 211 and associated data dependencies. For example, the embodiments herein may use a feed-forward neural network. In some embodiments, some or all of the neural network training may happen offline. Additionally or alternatively, some of the training may happen online. In some examples, offline development may include feature and model development, training, and/or test and evaluation.

In one embodiment, a repository that includes data about past data accessed and past the one or more operational step(s) 217 identified may supply the training and/or testing data. In one example, when the underlying system had accessed different types of the data 208 and/or the unified format data 211 from the one or more different external data sources 207, the system 201 may determine which operational steps to identify based on data from a feature repository and/or an online recommendation model that may be informed by the results of offline development. In one embodiment, the output of the machine learning model may include a collection of vectors of floats, where each vector represents a data source of the one or more different external data sources 207 and each float within the vector represents the probability that the one or more specified operational steps 217 may be identified. In some embodiments, the recent history of a data source may be weighted higher than older history data. For example, if a data source of the one or more different external data sources 207 had repeatedly provided the data 208 that resulted in the one or more relevant operational steps 217, the ML model may determine that the probability of that data source providing relevant data in the future is higher than for other data sources of the one or more different external data sources 207.

Once the machine learning model has been trained, the ML model may be used to identify the one or more operational steps 217 based on multiple different data sets. In some embodiments, the machine learning model that identifies these one or more operational steps 217 may be hosted on various cloud-based distributed processors (e.g., the ML processor 702) configured to perform the identification in real-time or substantially in real-time. Such cloud-based distributed processors may be dynamically added, in real-time, to the process of identifying actionable, the one or more operational steps 217. These cloud-based distributed processors may work in tandem with the prediction module 705 of FIG. 7 to generate outcome predictions, according to the various data inputs (sources) (e.g., the one or more different external data sources 207). These predictions may identify potential outcomes that would result from the identified one or more operational step(s) 217 being carried out. The predictions output by the prediction module 705 may include associated probabilities of occurrence for each prediction. The prediction module 705 may be part of a trained machine learning model that may be implemented using the ML processor 702. In some embodiments, various components of the machine learning module 701 may test the accuracy of the trained machine learning model using, for example, proportion estimation. This proportion estimation may result in feedback that, in turn, may be used by the feedback implementation module 704 in a feedback loop to improve the ML model and train the model with greater accuracy.

In some embodiments, the performance of the ML models described herein may be tuned (e.g., using a tuning module 707). In some cases, this may be a manual check, a comparison, or even a correction of some predicted results. In some cases, such interaction may be provided by feedback from users or other entities. With the one or more operational steps 217, credit bureaus employees and/or systems may have the ability to save it, alter it, like it, or otherwise dispose of it. In some cases, these actions may be transformed into labels for good, average, and bad for the generated one or more operational step(s) 217. In some cases, these labels may be used in the prediction process for the period after the actions are performed. Over time, this may result in an increase in the performance of ML models used in KPI predictions and also for associated operational step(s) generated machines. In parallel to the user interaction, there may be a developer UI for insight interaction from entities which may analyze and study the impact of the one or more operational step(s) 217 on the entity's credit score. Similarly, the one or more successful and average impact operational steps 217, and the one or more low impact operational steps 217 may be outlined and labeled accordingly for the further retraining of the corresponding ML engine.

The embodiments described herein may access multiple different types of data to generate the one or more operational step(s) 217. For example, the embodiments herein may access information generated by the accounting 207A and the payroll 207K software applications. These applications may provide information related to transactions, fees, accounts in other banks, the number of employees, invoices, trade credits, government reports, expenses, income, deposits, cash available, insurance information, tax returns, assets, and other types of information related to the entity 223. Still further, the systems herein may access the website analytics 207B and social media information including, for example, the number of visits to a specific website provided by the entity 223, the number of paid customers, information regarding customer acquisition channels, geographic data, gender, age, electronic devices used by customers to access web or application data, cost per acquisition (CPA), cost performance index (CPI), long term value (LTV), marketing expenses, application or website ratings, number of subscribers, or other related information.

Still further, the systems herein may access for instance the e-commerce data 207F including, for example, the entity's number of clients, average check amount, warehouse statistics including robotics information, compliance assurance process (CAP) information, payment information, sales statistics, seasonality information, or other related information. Additionally or alternatively, the systems herein may access the client relations management (CRM) data 207D including, for example, who the entity's partners and vendors are, the number of deals made, the number of customers, average check size, sales funnel information, CPA, CPI, LTV, or other related information. It will be understood here that the various types of the one or more different external data sources 207 are illustrated in FIG. 3 may not be comprehensive, and that other types of information and other sources of information may be accessed and implemented when identifying actionable, the one or more operational steps 217. In at least some cases, having more data sources and having different types of data sources may provide increased relevance and specificity in the identified the one or more operational steps 217.

In some cases, the operational step 401 may include providing KPIs values at 402 to the credit bureau 218. KPIs values include a set of parameters 403 (as shown in FIG. 4), which consists at least of KPIs identification information, KPIs values information, KPIs dynamics information, and KPI benchmark information. KPI identification information includes KPI name, type (e.g., for the future calculation, for comparing KPI values in two periods, for standalone events), group (e.g., profitability, liquidity, assets, debt, sales, efficiency), data period (day, week, month), etc. KPI value information includes one or more values. KPI dynamics information includes differences in values (e.g., difference between two or more periods). KPI benchmark information includes values in comparing with other entities in the same business industry, geographical location, etc. In some cases, the entity and/or credit bureau may be notified of these changes through a notification 409, or, if desired, the entity and/or credit bureau may opt to omit such notifications.

In another instance, the operational step 401 may include changing various operational parameters 406 associated with a credit scoring engine at 405 (as shown in FIG. 4). For example, in this way, the operational step 401 may be directly expressed in credit score reconsideration in accordance with credit score models and based on the unified format data 211 and/or KPIs and/or benchmarking, and/or forecasting, etc. In some cases, the entity and/or the credit bureau 218 may be notified of these changes via a notification 410 (as shown in FIG. 4) or, if desired, the entity and/or the credit bureau 218 may opt to omit such notifications.

Still further, at least in some cases, the operational step 401 may include at least some portion of credit score advice at 404 (as shown in FIG. 4) to credit bureau employees and/or systems. This credit score advice may include substantially any type of information that may assist a recommendation about entity credit score reconsideration. For example, a recommendation might recommend that the credit bureau 218 raise the entity's 223 credit score by a certain number of values and provide a rationale (as text, values, or a combination of them) for why this should be done. In some cases, the entity may be notified of these changes through a notification 411.

In some cases, at 407, the operational step 401 may include providing the unified format data 211 to the credit scoring engine of the credit bureau 218. Further, the unified format data 211 may be implemented in credit score models and/or provided to the credit score calculation engine 219 and may affect the credit score of the entity 223. In some cases, the entity may be notified of these changes through a notification 412 (as shown in FIG. 4) in the same way as the notification 410.

Still further, at least in some cases, at 408, the operational step 401 may include providing original format data to the scoring engine of the credit bureau 218. Original format data may be restructured by the internal data restructuring module(s) of the credit bureau 218 into a unified format. After that, unified format data may be implemented in credit score models and may affect the credit score of the entity 223. In some cases, the entity may be notified of these changes via a notification 413 (as shown in FIG. 4), which may be part of or different from the notifications 409-412.

Further, the credit bureau 218 receives the one or more operational steps 217 and implements it in credit score models and/or provides it to the credit score calculation engine 219. Further, the credit bureau 218 independently chooses which type of the operational steps 402 404, 405, 407, or 408 should be implemented into the credit score calculation model. In some embodiments, several types (402 404, 405, 407, 408) of the one or more operational steps 217 may be combined and used in one credit score calculation model. Further, the credit score calculation engine or credit bureau calculation engine 219 may have any of the existing implementations. Further, the credit bureau calculation engine 219 may also be driven by a machine learning module 220 (as shown in FIG. 2). Further, the machine learning module 220 may include various ML-related components. These components may include the machine learning (ML) processor 702, the inferential model 703, the feedback implementation module 704, the prediction module 705, and/or the neural network 706. Each of these components may be configured to perform different functions with respect to training and/or implementing a machine learning model which operates on the same principle as the machine learning module 215 which is a part of the post-processing service module 213.

After implementing the one or more operational steps 217 in the credit score calculation model and/or providing it to the credit score calculation engine 219, the credit bureau 218 sends information (at step 221) to the administrative service module 216 regarding the entity's credit score recalculation process. This information may be transferred by the data transfer unit and as an information message, machine-readable or human-readable instructions, etc. Further, the administrative service module 216 may transfer this information to the entity's interface module 222, where this information can be presented in a convenient review form, for example, in the form of widgets, dashboards, diagrams, etc.

Further, the computer system or system 201 interacts with the entity 223 through the entity's Interface module 222. The entity's Interface module 222 receives information from the administrative service module 216 and transmits information to the entity 223. The entity's Interface module 222 could be, for example, a website, a part of a website (e.g., web dashboard), a mobile application, a desktop application, voice recognition software, or other devices which allow communication or commands between the entity 223 and the system 201. Further, the entity 223 may have an account on the website and can log in to the account to enter (or update) information into the system 201 and/or the credit bureau 218, and receive information about credit score results evaluated by the credit bureau 218 and/or the system 201 and request custom scenarios to be evaluated. In addition to a website or mobile application, the entity's Interface module 222 may also have an electronic messaging capability wherein the entity's Interface module 222 may send electronic mail, text, or other electronic communication to the entity 223 and alert about updates, etc.

Computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments, one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive [data] to be transformed, transform the [data], output a result of the transformation to [perform a function], use the result of the transformation to [perform a function], and store the result of the transformation to [perform a function]. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “electro-mechanical data storage” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

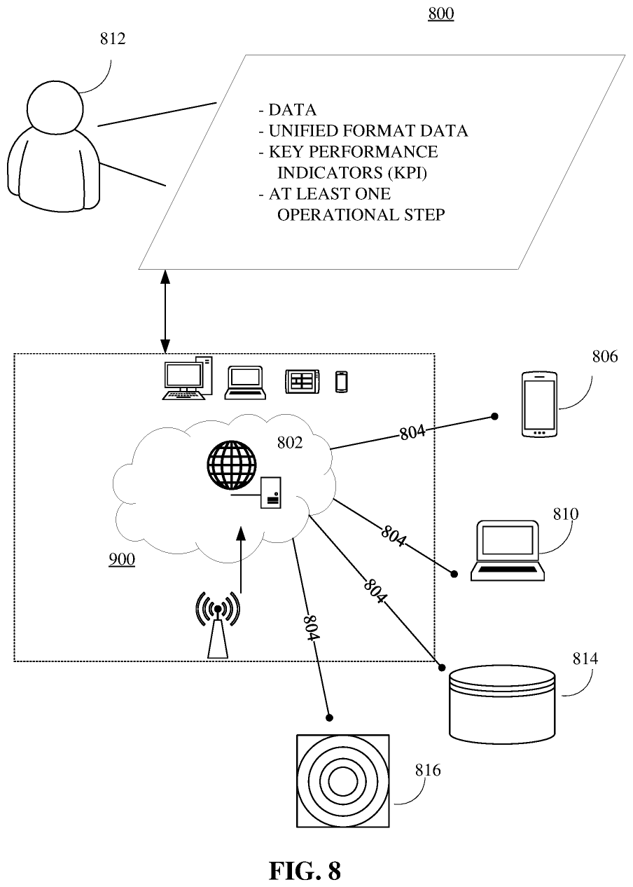

FIG. 8 is an illustration of an online platform 800 consistent with various embodiments of the present disclosure. By way of non-limiting example, the online platform 800 to facilitate incorporation of data types when assessing credit may be hosted on a centralized server 802, such as, for example, a cloud computing service. The centralized server 802 may communicate with other network entities, such as, for example, a mobile device 806 (such as a smartphone, a laptop, a tablet computer, etc.), other electronic devices 810 (such as desktop computers, server computers, etc.), databases 814, and sensors 816 over a communication network 804, such as, but not limited to, the Internet. Further, users of the online platform 800 may include relevant parties such as, but not limited to, end-users, administrators, service providers, service consumers, and so on. Accordingly, in some instances, electronic devices operated by the one or more relevant parties may be in communication with the platform.

A user 812, such as the one or more relevant parties, may access online platform 800 through a web based software application or browser. The web based software application may be embodied as, for example, but not be limited to, a website, a web application, a desktop application, and a mobile application compatible with a computing device 900.

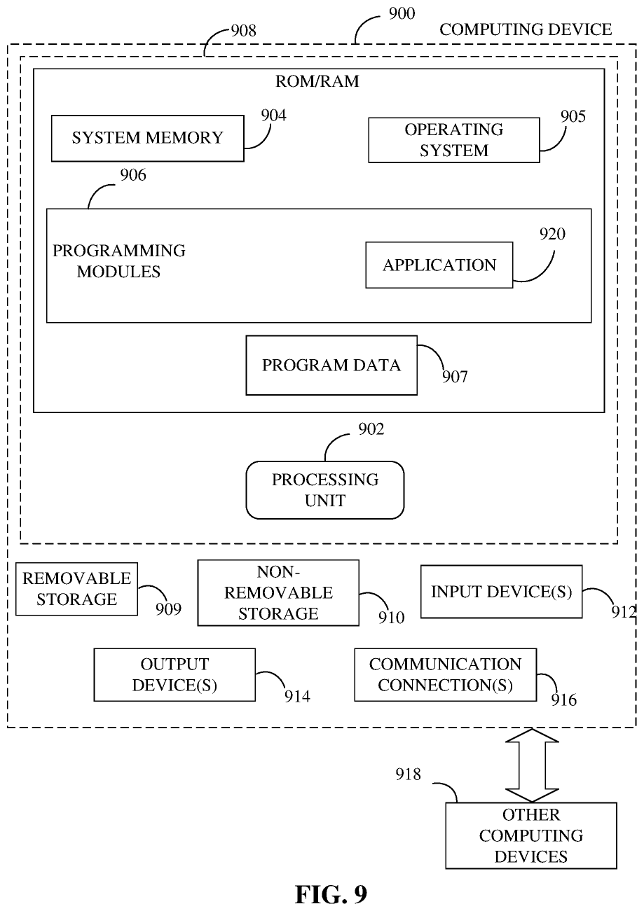

With reference to FIG. 9, a system consistent with an embodiment of the disclosure may include a computing device or cloud service, such as computing device 900. In a basic configuration, computing device 900 may include at least one processing unit 902 and a system memory 904. Depending on the configuration and type of computing device, system memory 904 may comprise, but is not limited to, volatile (e.g. random-access memory (RAM)), non-volatile (e.g. read-only memory (ROM)), flash memory, or any combination. System memory 904 may include operating system 905, one or more programming modules 906, and may include a program data 907. Operating system 905, for example, may be suitable for controlling computing device 900's operation. In one embodiment, programming modules 906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and non-volatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, a location sensor, a camera, a biometric sensor, etc. Output device(s) 914 such as a display, speakers, a printer, etc. may also be included. The aforementioned devices are examples and others may be used.

Computing device 900 may also contain a communication connection 916 that may allow device 900 to communicate with other computing devices 918, such as over a network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 904, including operating system 905. While executing on processing unit 902, programming modules 906 (e.g., application 920) may perform processes including, for example, one or more stages of methods, algorithms, systems, applications, servers, databases as described above. The aforementioned process is an example, and processing unit 902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A computer-implemented method comprising:
accessing data from external data sources, each data source in the external data sources being associated with a common objective;
restructuring the accessed data from a plurality of different data sources in the external data sources into a unified format;
optionally analyzing the accessed data to determine and calculate key performance indicators (KPIs);
optionally providing original format data from the plurality of different data sources;
generating at least one operational step that is to be taken to further the common objective;
transmitting the at least one operational step that is to be taken to further the common objective; and
implementing the at least one operational step.

2. The computer-implemented method of claim 1, wherein the at least one operational step includes providing the one or more determined and calculated KPIs to the credit bureau.

3. The computer-implemented method of claim 1, wherein the KPIs include a set of parameters consisting at least one of KPIs identification information, KPIs values information, KPIs dynamics information, and KPI benchmark information.

4. The computer-implemented method of claim 1, wherein the at least one operational step includes providing one or more credit score advices to the credit bureau.

5. The computer-implemented method of claim 1, wherein the at least one operational step includes changing at least one operational parameter associated with a credit scoring engine.

6. The computer-implemented method of claim 1, wherein the at least one operational step includes a notification indicating for the entity and/or credit bureau about one or more effects of the at least one operational step.

7. The computer-implemented method of claim 1, wherein the at least one operational step includes providing the unified format data to the credit bureau.

8. The computer-implemented method of claim 1, wherein the at least one operational step includes providing the original format data to the credit bureau.

9. The computer-implemented method of claim 1, wherein the step of accessing data from the plurality of different data sources is automatically performed on a specified periodic basis.

10. The computer-implemented method of claim 1 further comprises predicting, based on one or more factors, at least one outcome of the at least one operational step.

11. The computer-implemented method of claim 1 further comprises business valuation determination based on the data dependencies and the KPIs.

12. The computer-implemented method of claim 1, wherein the plurality of different data sources includes at least one of accountancy data, web and/or business analytics data, banks & banking data, customer relationship management (CRM) data, cryptocurrency data, eCommerce data, enterprise resource planning (ERP) data, e-wallets and payment processing data, logistics/third-party logistics data, marketing data, payroll data, point of sale (POS) terminal data, public registry data, subscription management data, eSignature and contract management data, non-fungible token assets data, or metaverse property data.

13. The computer-implemented method of claim 1, wherein restructuring the accessed data from the plurality of different data sources into the unified format includes standardizing the data according to which category of software application the data was received from.

14. The computer-implemented method of claim 1, wherein restructuring the accessed data from the plurality of different data sources into the unified format includes analyzing a class, type, or subtype of each account from a plurality of accounts and recoding the data into universal reference values.

15. The computer-implemented method of claim 1, wherein restructuring the accessed data from the plurality of different data sources into the unified format further includes storing the restructured data in a universal and denormalized data structure.

16. The computer-implemented method of claim 15, wherein the stored restructured data is categorized by application category in a columnar database.

17. A system comprising:
at least one physical processor; and
physical memory comprising computer-executable instructions that, when executed by the physical processor, cause the physical processor to:
access data from external data sources, each data source in the external data sources being associated with a common objective;
restructure the data from a plurality of different data sources in the external data sources into a unified format;
optionally analyze the accessed data to determine and calculate key performance indicators (KPIs) values;
optionally provide original format data from the plurality of different data sources;
generate at least one operational step that is to be taken to further the common objective;
transmit the at least one operational step that is to be taken to further the common objective; and
implement the at least one operational step.

18. The system of claim 17 further comprises a data accessing module, a data restructuring module, a data storage module, a post processing service module, an administrative service module, and an entity's interface module.

19. The system of claim 17, wherein a machine learning module is operated as a part of a calculation engine of a post-processing service module.

20. The system of claim 17, wherein the stage of determining and calculating the KPIs and/or stage of the at least one operational step generating that is to be taken is performed using machine learning.
